(19) United States
(12) Patent Application Publication
(10) Pub. No.: US 2008/0179770 A1
(43) Pub. Date: Jul. 31, 2008

(54) FREE FORM OPHTHALMIC LENS MOLD

(76) Inventors: Thomas R. Rooney, Jacksonville, FL (US); Gregory J. Hoffman, Jacksonville Beach, FL (US); Scott F. Ansell, Jacksonville, FL (US); David A. Katterhenry, Jacksonville, FL (US); Ture Kindt-Larsen, Holle (DK)

Correspondence Address: PHILIP S. JOHNSON;JOHNSON & JOHNSON, ONE JOHNSON & JOHNSON PLAZA, NEW BRUNSWICK, NJ, 08933-7003, US

(21) Appl. No.: 11/669,243

(22) Filed: Jan. 31, 2007

(51) Int. Cl. G02B 3/00

(52) U.S. Cl. 264/1.36; 425/174.4

(57) ABSTRACT

This invention includes methods and systems for forming an ophthalmic lens with a free form edge. In particular, the present invention provides a mold assembly including a vent portion around a circumference of a lens forming portion. A precision dose of lens forming mixture can be placed within the mold asembly to fill a lens forming portion of the mold assembly. Atmospheric gas may escape through the vent during lens assembly.

### FIELD OF THE INVENTION

This invention relates to a process to produce and package ophthalmic lenses. More specifically, the present invention relates to methods and apparatus for utilizing a free form edge mold part to mold an ophthalmic lens.

### BACKGROUND OF THE INVENTION

It is well known that contact lenses can be used to improve vision. Various contact lenses have been commercially produced for many years. Early designs of contact lenses were fashioned from hard materials. Although these lenses are still currently used in some applications, they are not suitable for all patients due to their poor comfort and relatively low permeability to oxygen. Later developments in the field gave rise to soft contact lenses, based upon hydrogels.

Hydrogel contact lenses are very popular today. These lenses are often more comfortable to wear than contact lenses made of hard materials. Malleable soft contact lenses can be manufactured by forming a lens in a multi-part mold where the combined parts form a topography consistent with the desired final lens.

Ophthalmic lenses are often made by cast molding, in which a monomer material is deposited in a cavity defined between optical surfaces of opposing mold parts. Multi-part molds used to fashion hydrogels into a useful article, such as an ophthalmic lens, can include for example, a first mold part with a convex portion that corresponds with a back curve of an ophthalmic lens and a second mold part with a concave portion that corresponds with a front curve of the ophthalmic lens. To prepare a lens using such mold parts, an uncured hydrogel lens formulation is placed between a front curve mold part and a back curve mold part. The mold parts are brought together to shape the lens formulation according to desired lens parameters. Traditionally, a lens edge was formed about the perimeter of the formed lens by compression of an edge formed into the mold parts which penetrates the lens formulation and incises it into a lens portion and an excess ring portion. The lens formulation was subsequently cured, for example by exposure to heat and light, thereby forming a lens.

Following cure, mold portions are separated and the lens remains adhered to one of the mold portions. The lens and the excess polymer ring must be separated and the excess polymer ring discarded. Excess ring removal is usually accomplished by various mechanisms during demold. Due to the compression of the edge forming perimeter of the mold parts, the mold parts are discarded and new parts are injection molded to form a next lens. In addition, it is important to manage the removal of the excess polymer ring so that it properly discarded and does not interfere with other manufacturing steps or make its way into a product package and shipment to an end user.

Therefore, it would be advantageous to provide apparatus and methods that enable a lens perimeter to form without using a compression edge and preferably without the formation of an excess polymer ring.

### SUMMARY OF THE INVENTION

Accordingly, the present invention provides apparatus and methods for forming an ophthalmic lens in a reusable mold with a free form edge. The free form edge eliminates the need for the removal of any excess polymer ring, and in some embodiments, allows for reuse of one or more of the mold parts, used to form the ophthalmic lens. The present invention teaches the use of precision dosing of lens forming mixture into a mold part used to fashion the ophthalmic lens and innovative mold designs can be used to facilitate the use of the mold part with a free form lens edge.

### DESCRIPTION OF THE DRAWINGS

FIG. 1 illustrates an ophthalmic lens mold assembly for forming an ophthalmic lens via a free form edge.

FIG. 2 illustrates a close up profile of a portion of n ophthalmic lens mold assembly for forming an ophthalmic lens via a free form edge.

FIG. 3 illustrates a close up of a vent gap and alignment taper portion of a mold assembly according to some embodiments of the present invention.

FIG. 4 illustrates deposition of a precision dose of lens formulation in a free form edge lens mold assembly.

FIG. 5 illustrates dispersion of a precision dose of lens formulation in a free form edge lens mold assembly.

FIG. 6 illustrates a flow chart of steps that may be taken to form a free edge on an ophthalmic lens.

FIG. 7 illustrates apparatus stations that may be used to fashion an ophthalmic lens.

### DETAILED DESCRIPTION OF THE INVENTION

The present invention relates to the use of a mold assembly capable of molding an ophthalmic lens with a free formed edge. Essentially, a specific amount of lens forming mixture is precision dosed into a first mold part and a second mold part is assembled with the first mold part thereby forming a vent gap and shaping the lens forming mixture into an ophthalmic lens. The vent gap facilitates uniform dispersion of lens forming mixture during assembly of the first mold part to the second mold part.

### Definitions

As used herein, “released from a mold,” means that a lens is either completely separated from the mold, or is only loosely attached so that it can be removed with mild agitation or pushed off with a swab.

As used herein “lens” or “ophthalmic lens” refers to any ophthalmic device that resides in, on or in close proximity to the eye. These devices can provide optical correction or may be cosmetic. For example, the term lens can refer to a contact lens, intraocular lens, overlay lens, ocular insert, optical insert or other similar device through which vision is corrected or modified, or through which eye physiology is cosmetically enhanced (e.g. iris color) without impeding vision.

As used herein, the term “lens forming mixture” refers to a monomer or prepolymer material which can be cured to form an ophthalmic lens. Various embodiments can include mixtures with one or more additives such as: UV blockers, tints, photoinitiators or catalysts, and other additives providing benefit to an ophthalmic lens. Specific examples of lens forming mixtures are more fully described below.

### Molds

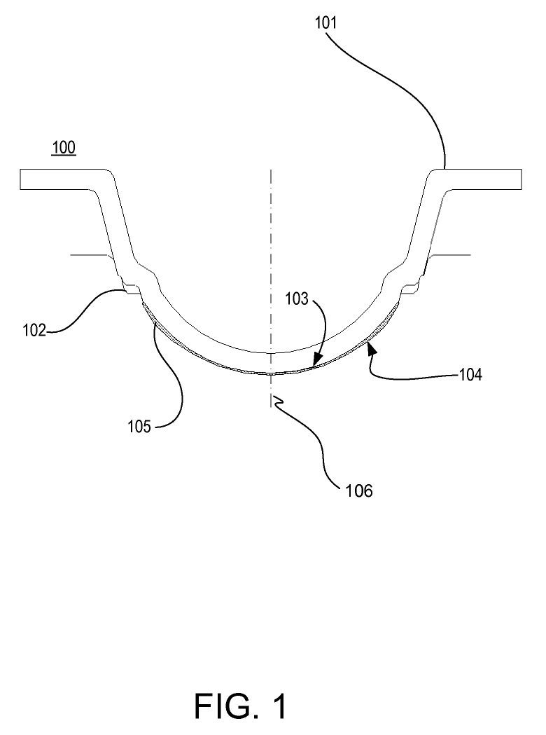

Referring now to FIG. 1, a diagram of an exemplary mold for an ophthalmic lens is illustrated. As used herein, the terms “mold” and “mold assembly” refer to a form 100 having a cavity 105 into which a lens forming mixture can be dispensed such that upon reaction or cure of the lens forming mixture (not illustrated), an ophthalmic lens of a desired shape is produced. The molds and mold assemblies 100 of this invention are made up of more than one “mold parts” or “mold pieces” 101-102. The mold parts 101-102 can be brought together such that a cavity 105, in which a lens can be fashioned, is formed by combination of the mold parts 101-102. This combination of mold parts 101-102 is preferably temporary. Upon formation of the lens, the mold parts 101-102 can again be separated for removal of a fashioned lens (not shown.

A “mold part” as the term is used in this specification refers to a portion of mold 101-102, which when combined with another portion of a mold 101-102 forms a mold 100 (also referred to as a mold assembly 100). At least one mold part 101-102 has at least a portion of its surface 103-104 in contact with the lens forming mixture such that upon reaction or cure of the lens forming mixture that surface 103-104 provides a desired shape and form to the portion of the lens with which it is in contact. The same is true of at least one other mold part 101-102.

Thus, for example, in a preferred embodiment a mold assembly 100 is formed from two parts 101-102, a female concave piece (front curve mold part) 102 and a male convex piece (back curve mold part) 101 with a cavity 105 formed between them. The portion of the concave surface 104 which makes contact with lens forming mixture has the curvature of the front curve of an ophthalmic lens to be produced in the mold assembly 100 and is sufficiently smooth and formed such that the surface of a ophthalmic lens formed by polymerization of the lens forming mixture which is in contact with the concave surface 104 is optically acceptable.

The back curve mold part 101 has a convex surface 103 which contacts the lens forming mixture and has the curvature of the back curve of a ophthalmic lens to be produced in the mold assembly 100. The convex surface 103 is sufficiently smooth and formed such that the surface of a ophthalmic lens formed by reaction or cure of the lens forming mixture in contact with the back surface 103 is optically acceptable. Accordingly, the inner concave surface 104 of the front curve mold part 102 defines the outer surface of the ophthalmic lens, while the outer convex surface 103 of the back mold piece 101 defines the inner surface of the ophthalmic lens.

In some preferred methods a mold assembly 100 is injection molded according to known techniques, however, embodiments can also include one or more mold parts 101-102 fashioned by other techniques including, for example: lathing, diamond turning, or laser cutting.

As used herein “lens forming surface” means a surface 103-104 that is used to mold a lens. In some embodiments, any such surface 103-104 can have an optical quality surface finish, which indicates that it is sufficiently smooth and formed so that a lens surface fashioned by the polymerization of a lens forming material in contact with the molding surface is optically acceptable.

Further, in some embodiments, the lens forming surface 103-104 can have a geometry that is necessary to impart to the lens surface the desired optical characteristics. Geometries can therefore include a generally spherical about a centroid 106. Other shapes can include, without limitation, aspherical and cylinder power, wave front aberration correction, corneal topography correction and the like as well as any combinations thereof.

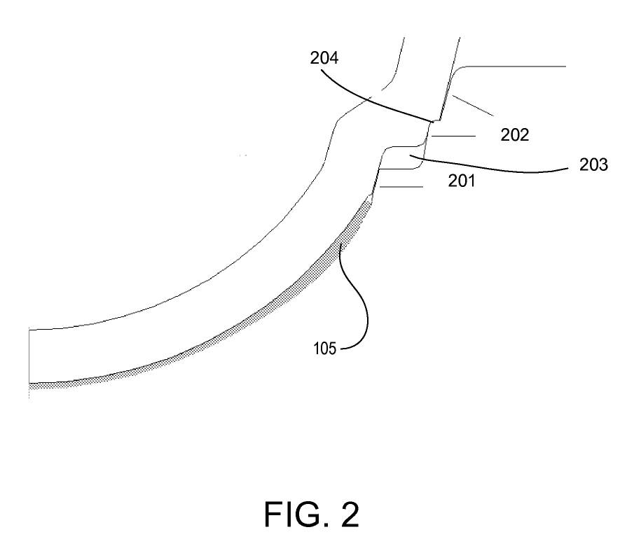

Referring now to FIG. 2, a close up, cut away view of a vent portion 201 of a mold assembly and an alignment tapers portion 202 of a mold assembly 202 are illustrated. The vent portion 201 includes a narrow passageway between a mold cavity 105 and a space exterior to the mold cavity 105. The vent 201 is sufficiently wide to allow an atmospheric gas to escape the mold cavity 105 during mold part 101-102 assembly, but not allow the escape of the forming mixture. Atmospheric gas can include, for example, air or an inert gas, such as nitrogen. Other atmospheres may also be included according to the needs of a particular molding application.

In some preferred embodiments, the vent can include a space of about 0.001 mm to 0.20 mm and some most preferred embodiments the vent can include a space of about 0.003 mm to about 0.10 mm.

In some embodiments, the vent 201 can be fluidly connected to an anterior chamber 203. The anterior chamber 203 can be formed by a wall portion connecting the lens forming surfaces 103-104 to the alignment tapers 202 of a mold assembly 100. In some embodiments, the anterior chamber 203 can include a channel of about 0.09 mm to about 0.20 mm wide.

The alignment tapers 202 can generally taper inward towards a centroid 106 of the mold assembly 100. During assembly of the front curve mold part 101 and the back curve mold part 102, the alignment tapers 202 will guide one or more of: the back curve mold part 101 and the front curve mold part 102 until the centroid 106 of each mold part 101-102 is aligned to form a centroid of the mold assembly 106.

In another aspect, a shoulder portion 204 of the mold assembly 100 can provide support to a back curve mold part 101 as it is assembled to a front curve mold part 102. Engagement of the shoulder 204, wherein the back curve 101 and the front curve 102 meet, can specify a width of the lens forming cavity 105 created between the back curve mold part 101 and the front curve mold part 102.

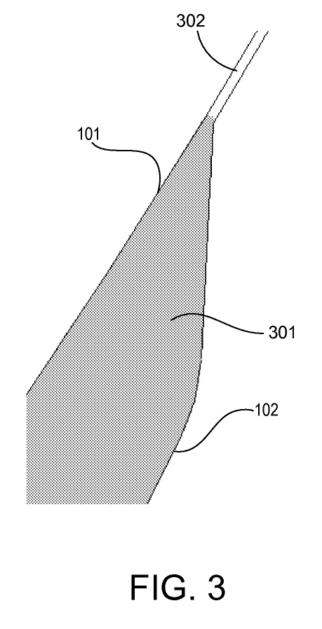

Referring now to FIG. 3, a further close up of some embodiments of the present invention is illustrated with a precise amount of lens forming mixture 301 that has been dosed between a back curve mold part 101 and a front curve mold part 102 will fill a lens forming cavity until the lens forming mixture encounters a vent portion 302. According to such embodiments, the width of the vent portion 302 is sufficiently narrow to resist the lens forming mixture 301 from entering the vent portion 302, but allowing any gas within the lens cavity to escape. Resistance of the lens forming mixture 301 from entering the vent portion 302 can be useful to facilitate the lens forming mixture flowing more evenly throughout the lens cavity 105.

Precision dosing specific amounts of lens forming mixture 301 into a lens cavity enables the lens forming mixture to be formed into the shape of an ophthalmic lens, without overflowing into the vent area 302. Precision dosing in some preferred embodiments includes a range of plus or minus 5% and some more preferred embodiments, a range of plus or minus 3%. Accordingly, preferred ranges include a range of about plus or minus 1 mg. on a 30 mg. dose.

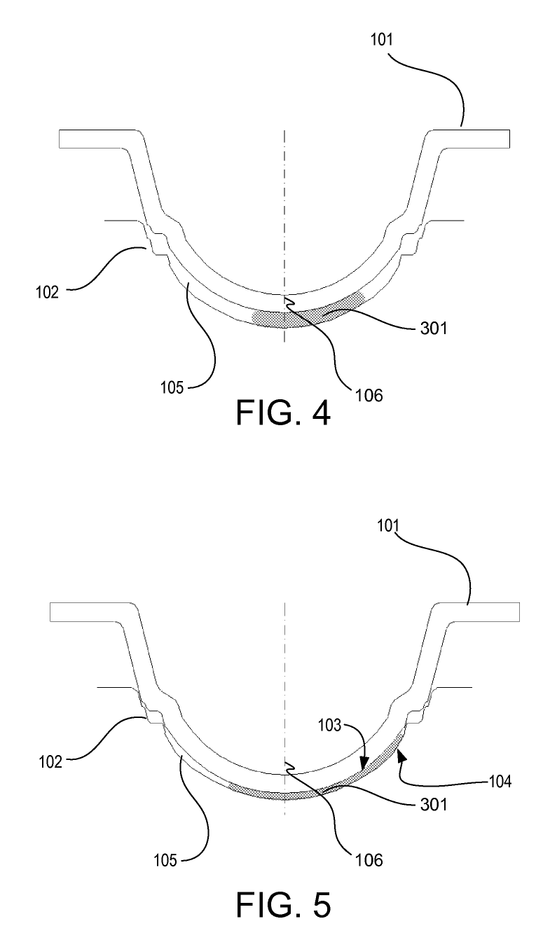

Referring now to FIG. 4, in some embodiments, a dose of lens forming mixture 301 may not be completely centered within the lens mold. However the force of the assembly of the old parts 101-102 can pressure the lens forming mixture to spread out within the mold cavity 105.

Referring now to FIG. 5, the lens forming mixture 301 will continue to spread as pressure is additionally applied to combine the back curve mold part 101 with the front curve mold part 102. According to some embodiments, assembly of the mold parts 101-102 can be under force control such that, as the mold parts 101-102 are combined closer together, the cavity becomes filled with the lens forming mixture 301 and the moment that the cavity 105 is filled, the force needed to bring the lens forming mixture into the vents 302 is substantially increased indicating a stop point for the assembly. In some embodiments, a high viscous prepolymer lens forming mixture 301 further facilitates the creation of resistance of the lens forming mixture entering into the vent 302.

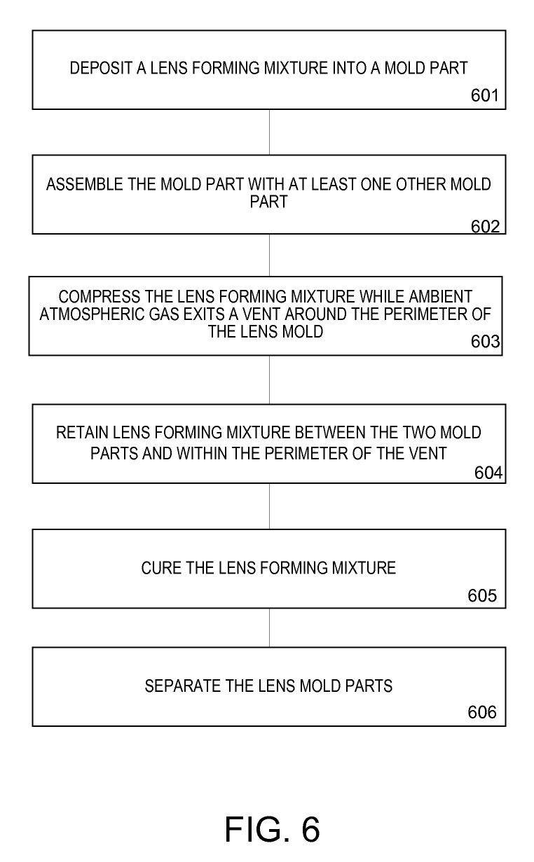

Referring now to FIG. 6, a flow diagram illustrates exemplary steps that may be implemented in some embodiments of the present invention. It is to be understood that some or all of the following steps may be implemented in various embodiments of the present invention. At 601, the lens forming mixture (described in more detail below) is deposited into a first mold part 102, which is utilized to shape the ophthalmic lens. In preferred embodiments, the lens forming mixture is a prepolymer with a viscosity in the range of about 10,000 cps to 5,000,000 cps. Dosing can be accomplished with a micro dose pump with precision tolerance of plus or minus 2 milligrams of a predetermined dose amount. In preferred embodiments, exemplary dose amounts can include between about 20 milligrams and 50 milligrams of lens forming mixture. The precision dosing allows the lens forming cavity 105 to fill with lens forming mixture 301 while the mold parts 101-102 are coupled together without the lens forming mixture entering into the vent area 302. By volume, preferred embodiments include a dispensing accuracy by volume of between 2.5 micro liters to 3.0 micro liters and a dispensing accuracy by position of within 75 microns or less.

At 602, the first mold part 102 can be assembled with at least one other mold part (the second mold part) 101 to shape the deposited lens forming mixture into the desired shape of a lens. In some preferred embodiments, the mold parts 101-102 are assembled with an alignment accuracy of within 50 microns. In some preferred embodiments, the assembly force, (sometimes referred to as stopping load) will be between 1 kilogram and 10 kilogram of force. Some more preferred embodiments can include a stopping force of between about 2 kg to 6 kg of force. According to some embodiments of the present invention, because a stopping load triggers the stopping of assembly motion, the mold parts 101-102 do not touch at the lens edge intersection and therefore do not physically deform each other during the assembly process. Therefore, in some embodiments, one or both of the mold parts 101-102 may be subsequently reused to form ophthalmic lenses.

At 603, the lens forming mixture 301 is compressed by the force of the mold parts 101-102 assembly while ambient atmospheric gas exits via the vent portion 302 around the perimeter of the mold assembly 100. The lens forming mixture 301 is dispersed within the mold assembly 100 while, at 604 the lens forming mixture 301 is retained between the two mold parts 101-102 and within the perimeter of the vent 302. Since the lens forming mixture 301 is only dispersed until a stopping force is reached, the edge of a lens formed is not defined by an edge cut by the mold parts 101-102, but free formed by the flow of the lens forming mixture 301.

At 605, the lens forming mixture is cured. Curing can be accomplished, for example, via various means known in the art, such as, exposure of the lens forming mixture 301 to actinic radiation, exposure of the lens forming mixture 301 to elevated heat (i.e. 40° C. to 75° C.), or exposure to both actinic radiation and elevated heat.

At 606, the first mold part 101 can be separated from the second mold part 102 in a demolding process such that a lens formed between the mold parts 101-102 may be accessed.

### Apparatus

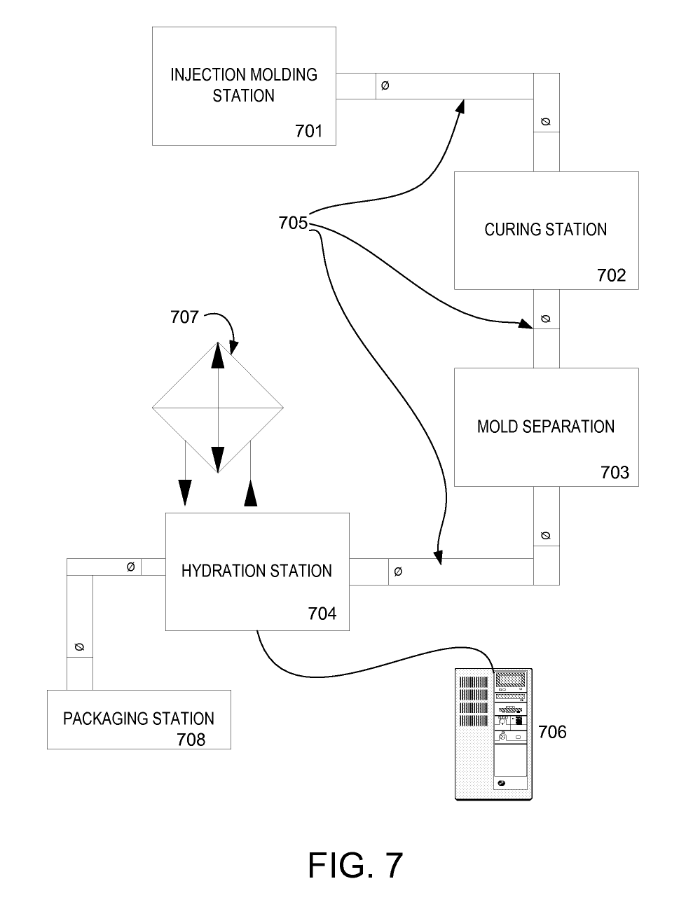

Referring now to FIG. 7, a block diagram is illustrated of apparatus contained in processing stations 701-704 that can be utilized in implementations of the present invention. In some preferred embodiments, processing stations 701-704 can be accessible to ophthalmic lenses via a transport mechanism 705. The transport mechanism 305 can include for example one or more of: a robot, a conveyor and a rail system in conjunction with a locomotion means that may include, a conveyor belt, chain, cable or hydraulic mechanism powered by a variable speed motor or other known drive mechanism (not shown).

Some embodiments can include back surface mold parts 101 placed in pallets (not shown). The pallets can be moved by the transport mechanism 705 between two or more processing stations 701-704. A computer or other controller 706 can be operatively connected to the processing stations 701-704 to monitor and control processes at each station 701-704 and also monitor and control the transport mechanism 705 to coordinate the movement of lenses between the process stations 701-704.

Processing stations 701-704 can include, for example, an injection molding station 701. At the injection molding station 701, injection molding apparatus deposits a quantity of a lens forming mixture, such as, for example, a silicone hydrogel as described above, into the front curve mold portion 102 and preferably completely covers the mold surface 104 with the lens forming mixture.

In some embodiments, polymerization of lens forming mixture can be carried out in an atmosphere with controlled exposure to oxygen, including, in some embodiments, an oxygen-free environment, because oxygen can enter into side reactions which may affect a desired optical quality, as well as the clarity of the polymerized lens. In some embodiments, the lens mold halves are also prepared in an atmosphere that has limited oxygen or is oxygen-free. Methods and apparatus for controlling exposure to oxygen are well known in the art.

A curing station 702 can include apparatus for polymerizing the lens forming mixture. Polymerization is preferably carried out by exposing the lens forming mixture, to polymerization initiating conditions. The curing step can include exposure of the lens forming mixture to one or more of: electromagnetic radiation in the form of X-rays, ultraviolet light, visible light, particle radiation, electro beam radiation. Radiation can include wavelengths ranging from about 280 nm to 650 nm and can include pulsed or continuous radiation sources. Exemplary radiation intensities can include between about 1 mW/cm² to about 1000 mW/cm². A mold assembly may also be heated to upwards of 90° C. In some preferred embodiments, cure times may range between up to about 120 seconds, although longer cure times are also possible.

Curing station 702 therefore includes apparatus that provide a source of initiation of the lens forming mixture deposited into the front curve mold 102. The source of initiation can include for example, one or more of: actinic radiation and heat. In some embodiments, actinic radiation can be sourced from bulbs under which the mold assemblies travel. The bulbs can provide an intensity of actinic radiation in a given plane parallel to the axis of the bulb that is sufficient to initiate polymerization.

In some embodiments, a curing station 302 heat source can be effective to raise the temperature of the lens forming mixture to a temperature sufficient to assist the propagation of the polymerization and to counteract the tendency of the lens forming mixture to shrink during the period that it is exposed to the actinic radiation and thereby promote improved polymerization.

In some embodiments, a source of heat can include a duct, which blows warm gas, such as, for example, N₂ or air, across and around the mold assembly as it passes under the actinic radiation bulbs. The end of the duct can be fitted with a plurality of holes through which warm gas passes. Distributing the gas in this way helps achieve uniformity of temperature throughout the area under the housing. Uniform temperatures throughout the regions around the mold assemblies can facilitate more uniform polymerization.

A mold separation station 703 can include apparatus to separate the back curve mold part 101 from the front curve mold part 102. Separation can be accomplished for example with mechanical fingers and high speed robotic movement that pry the mold parts apart.

In some embodiments, a cured lens which includes a polymer/diluent mixture can be treated by exposure to a hydration solution at a hydration station 704. A lens is formed having a final size and shape which are quite similar to the size and shape of the original molded polymer/diluent article.

### Lens Materials

Ophthalmic lenses suitable for use with the current invention include those made from prepolymers.

In some exemplary embodiments of the present invention, lenses can be formed from prepolymer compositions that include silicone prepolymers, polyvinyl silicone, or poly-HEMA. Exemplary prepolymers can have a peak molecular weight between about 25,000 and about 100,000, preferably between 25,000 and 80,000 and a polydispersity of less than about 2 to less than about 3.8 respectively and covalently bonded thereon, at least one cross-linkable functional group.

In some exemplary embodiments of the present invention, it is desirable to limit shrinkage, expansion and related attributes through the use of hydrogels formed from a crosslinkable prepolymer having a relatively low molecular weight and low polydispersity.

As used herein “poly-HEMA” means polymers which comprise 2-hydroxethyl methacrylate repeat units. The poly-HEMA utilized in some embodiments of the present invention has a peak molecular weight in the range from about 25,000 with a polydispersity of less than about 2 to a peak molecular weight of about 100,000 with a polydispersity of less than about 3.8. Preferably, the can have a peak molecular weight between about 30,000 with a polydispersity of less than about 2 and about 90,000 with a polydispersity of less than about 3.5. More preferably, the compositions can have a peak molecular weight between about 30,000 with a polydispersity of less than about 2 and about 80,000 with a polydispersity of less than about 3.2. Suitable poly-HEMA may also have a peak molecular weight below about 100,000 and a polydispersity of less than about 2, and preferably a peak molecular weight between about 45,000 and 100,000 and a polydispersity of less than about 2.5. In certain embodiments the polydispersity is less than about 2.5, preferably less than about 2, more preferably less than about 1.7 and in some embodiments is less than about 1.5. The term poly-HEMA as used above and throughout this specification will include polymers prepared from 2-hydroxethyl methacrylate alone as well as copolymers with other monomers or co-reactants as further described below.

Suitable comonomers which may be polymerized with HEMA monomer include hydrophilic monomers such as vinyl-containing monomers and hydrophobic monomers as well as tinted monomers giving light absorption at different wavelengths. The term “vinyl-type” or “vinyl-containing” monomers refer to monomers comprising the vinyl group (—CR═CR′R″, in which R, R′ and R″ are monovalent substituents), which are known to polymerize relatively easily. Suitable vinyl-containing monomers include N, N-dimethyl acrylamide (DMA), glycerol methacrylate (GMA), 2-hydroxyethyl methacrylamide, polyethylene glycol monomethacrylate, methacrylic acid (MAA), acrylic acid, N-vinyl lactams (e.g. N-vinyl-pyrrolidone, or NVP), N-vinyl-N-methyl acetamide, N-vinyl-N-ethyl acetamide, N-vinyl-N-ethyl formamide, N-vinyl formamide, vinyl carbonate monomers, vinyl carbamate monomers, oxazolone monomers mixtures thereof and the like.

Some preferred hydrophilic monomers which may be incorporated into polymer utilized in some embodiments can include hydrophilic monomers such as DMA, GMA, 2-hydroxyethyl methacrylamide, NVP, polyethylene glycol monomethacrylate, MAA, acrylic acid and mixtures thereof. DMA, GMA and MAA are the most preferred in certain embodiments.

Suitable hydrophobic monomers include silicone-containing monomers and macromers having a polymerizable vinyl group. Preferably the vinyl group is a methacryloxy group. Examples of suitable silicone containing monomers and macromers include mPDMS type monomers, which comprise at least two [—Si—O—] repeating units, SiGMA type monomers which comprise a polymerizable group having an average molecular weight of about less than 2000 Daltons, a hydroxyl group and at least one “—Si—O—Si—” group and TRIS type monomers which comprise at least one Si(OSi—)₃ group. Examples of suitable TRIS monomers include methacryloxypropyltris(trimethylsiloxy)silane, methacryloxypropylbis(trimethylsiloxy)methylsilane, methacryloxypropylpentamethyldisiloxane, mixtures thereof and the like.

Preferably, the mPDMS type monomers comprise total Si and attached O in an amount greater than 20 weight percent, and more preferably greater than 30 weight percent of the total molecular weight of the silicone-containing monomer. Suitable mPDMS monomers have the

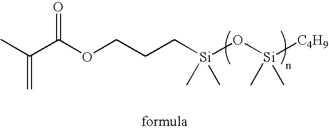

Examples of suitable linear mono-alkyl terminated polydimethylsiloxanes (“mPDMS”) include:

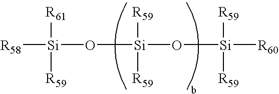

where b=0 to 100, where it is understood that b is a distribution having a mode approximately equal to a stated value, preferably 4 to 16, more preferably 8 to 10; R₅₈ comprises a polymerizable monovalent group containing at least one ethylenically unsaturated moiety, preferably a monovalent group containing a styryl, vinyl, (meth)acrylamide or (meth)acrylate moiety, more preferably a methacrylate moiety; each R₅₉ is independently a monovalent alkyl, or aryl group, which may be further substituted with alcohol, amine, ketone, carboxylic acid or ether groups, preferably unsubstituted monovalent alkyl or aryl groups, more preferably methyl; R₆₀ is a monovalent alkyl, or aryl group, which may be further substituted with alcohol, amine, ketone, carboxylic acid or ether groups, preferably unsubstituted monovalent alkyl or aryl groups, preferably a C₁₋₁₀ aliphatic or aromatic group which may include hetero atoms, more preferably C₃₋₈ alkyl groups, most preferably butyl; and R₆₁ is independently alkyl or aromatic, preferably ethyl, methyl, benzyl, phenyl, or a monovalent siloxane chain comprising from 1 to 100 repeating Si—O units.

Preferably in the SiGMA type monomer silicon and its attached oxygen comprise about 10 weight percent of said monomer, more preferably more than about 20 weight percent. Examples of SiGMA type monomers include monomers of Formula I

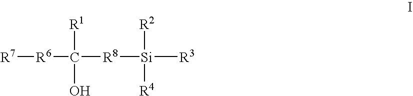

Wherein the substituents are as defined in U.S. Pat. No. 5,998,498, which is incorporated herein by reference.

Specific examples of suitable SiGMA type monomers include 2-propenoic acid, 2-methyl-2-hydroxy-3-[3-[1,3,3,3-tetramethyl-1-[trimethylsilyl)oxy]disiloxanyl]propoxy]propyl ester

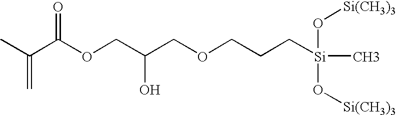

and (3-methacryloxy-2-hydroxypropyloxy)propyltris(trimethylsiloxy)silane

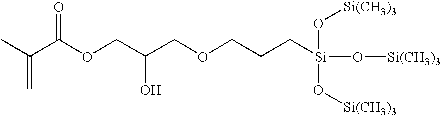

Yet further examples of SiGMA type monomers include, without limitation (3-methacryloxy-2-hydroxypropyloxy)propylbis(trimethylsiloxy)methylsilane.

In some exemplary embodiments, hydrophobic monomers, such as, for example, methylmethacrylate and ethylmethacrylate may be incorporated into the poly-HEMA to modify the water absorption, oxygen permeability, or other physical properties as demanded by the intended use. Exemplary amounts of comonomer can be less than about 50 weight %, and preferably between about 0.5 and 40 weight %. Specific ranges can depend upon a desired water content for the resulting hydrogel, a solubility of the monomers selected and diluent selected. For example, in embodiments wherein the comonomer comprises MMA, it may be beneficially included in amounts less than about 5 weight % and preferably between about 0.5 and about 5 weight %. In other embodiments the comonomer may comprise GMA in amounts up to about 50 weight %, preferably between about 25 weight % and about 45 weight %. In still other embodiments the comonomer can comprise DMA in amounts up to about 50 weight %, and preferably in amounts between about 10 and about 40 weight %.

Some embodiments can also include the use of initiators and chain transfer agents. Various embodiments may therefore include the use of any desirable initiators, including, without limitation, thermally activated initiators, UV and/or visible light photoinitiators and the like and combinations thereof. Suitable thermally activated initiators include lauryl peroxide, benzoyl peroxide, isopropyl percarbonate, azobisisobutyronitrile, 2,2-azobisisobutyronitrile, 2,2-azobis-2-methylbutyronitrile and the like. Preferred initiators comprise 2,2-azobis-2-methylbutyronitrile (AMBM) and/or 2,2-azobisisobutyronitrile (AIBN).

The initiator is used in the lens forming mixture in effective amounts, e.g., from about 0.1 to about 5 weight percent, and preferably from about 0.1 to about 2 parts by weight per 100 parts of reactive monomer.

In some exemplary embodiments, HEMA monomer and any desired comonomers can be polymerized via free radical polymerization. The polymerization is conducted in any solvent, which is capable of dissolving the HEMA monomer and the resulting poly-HEMA during the polymerization. Suitable solvents for the polymerization of the HEMA monomer include alcohols, glycols, polyols, aromatic hydrocarbons, ethers, esters, ester alcohols, ketones, sulfoxides, pyrrolidones, amides mixtures thereof and the like. Specific solvents include methanol, ethanol, isopropanol, 1-propanol, methyllactate, ethyllactate, isopropyllactate, glycolethers like the Dowanol range of products, ethoxypropanol, DMF, DMSO, NMP, cyclohexanone, mixtures thereof and the like. Preferred solvents include alcohols having one to four carbon atoms and more preferably, ethanol, methanol and isopropanol. Sufficient solvent must be used to dissolve the monomers. Generally about 5 to about 25 weight % of monomers in the solvent is suitable.

The free radical polymerization can be conducted at temperatures between about 40° and about 150° C. The upper limit can be determined by the pressure limitation of the equipment available and the ability to handle the polymerization exotherm. The lower limit can be determined by the maximum acceptable reaction time and/or properties of initiator. For polymerization at about ambient pressure a preferred temperature range is between about 50° C. and about 110° C., and more preferably between about 60° to about 90° C. and for times necessary to provide the desired degree of conversion. A free radical polymerization reaction generally proceeds with about between about 90 to about 98% of the monomer reacting within about one to about 6 hours. If a more complete conversion is desired, (greater than about 99%), the reaction may be conducted from about 12 to about 30 hours, and more preferably between about 16 and about 30 hours. Since the poly-HEMA prepared in the polymerization step in many instances will undergo a fractionation to remove low molecular weight species, it may not, in all embodiments, be required to bring the polymerization process to a high degree of conversion.

In some embodiments, chain transfer agents may optionally be included. Chain transfer agents useful in forming the poly-HEMA may have chain transfer constants values of greater than about 0.001, preferably greater than about 0.2, and more preferably greater than about 0.5 Exemplary chain transfer agents include, without limitation, aliphatic thiols of the formula R—SH wherein R is a C₁ to C₁₂ aliphatic, a benzyl, a cycloaliphatic or CH₃(CH₂)ₓ—SH wherein x is 1 to 24, benzene, n-butyl chloride, t-butyl chloride, n-butyl bromide, 2-mercapto ethanol, 1-dodecyl mercaptan, 2-chlorobutane, acetone, acetic acid, chloroform, butyl amine, triethylamine, di-n-butyl sulfide and disulfide, carbon tetrachloride and bromide, and the like, and combinations thereof. Generally, about 0 to about 7 weight percent based on the total weight of the monomer formulation will be used. Preferably dodecanethiol, decanethiol, octanethiol, mercaptoethanol, or combinations thereof is used as the chain transfer agent.

In some embodiments it is preferred to polymerize the poly-HEMA without a chain transfer agent. Accordingly, alcohols may be used as a solvent in some embodiments, preferably alcohols having one to four carbon atoms, and preferably the solvent is methanol, ethanol, isopropanol and mixtures thereof.

In some exemplary embodiments, the poly-HEMA formed in the free radical polymerization may have a polydispersity which is too high for direct use in molds according to the present invention. This may be caused by the reaction kinetics of the process in which an important terminating reaction is a combination of two growing polymer chains. Accordingly, when using free radical polymerization to form a poly-HEMA it may be advantageous to purify the poly-HEMA either before or after functionalization to remove the polymer having molecular weights outside the desired range. Any method capable of separating a material based upon molecular weight may be used.

The non-solvent must reduce at least one of the parameters to insure the selective precipitation of the poly-HEMA having a peak molecular weight of greater than about 90,000. If the non-solvent increases the solubility parameters of the separation mixture, precipitation is much less a function of the molecular weight, and poly-HEMA within the desired molecular weight range is lost.

In some exemplary embodiments, a poly-HEMA can be utilized with an amount of polymer molecules with molecular weight less than about 15,000 that is less than about 10%, preferably less than about 5% and more preferably less than about 2%. Fractionation methods are flexible and can be adapted according to the nature of the specific polymer. The conditions required to obtain the desired degree of polydispersity can easily be determined by simple small-scale experiments using the above disclosure. Suitable temperature ranges include about 5 to about 50° C. Suitable standing times include between about 1 hour and to about 7 days.

In some embodiments only the low molecular weight fraction is removed from the poly-HEMA. This can be done by the solvent/non-solvent process described above. In a preferred embodiment the low molecular weight material is removed during the washing step after the poly-HEMA has been functionalized.

In some embodiments, a poly-HEMA may also be formed directly by anionic polymerization or controlled free radical polymerization, such as with a TEMPO type polymerization, ATRP (atom transfer radical polymerization), GTP (Group transfer polymerization), and RAFT (Reversible addition-fragmentation chain transfer polymerization).

For example, for anionic polymerization the desired silyl protected monomer can be dissolved in a suitable solvent, such as THF solution. The reaction is conducted at reduced temperature, between about −60° C. and about −90° C. using known initiators such as 1,1-diphenylhexyllithium as initiator. The polymerization may be terminated by conventional means, such as, but not limited to degassed methanol.

The poly-HEMA compositions having a specific molecular weight range and polydispersity can be used to make crosslinkable prepolymers with well-defined polydispersity and molecular weight. As but one example, the crosslinkable prepolymers can have acrylic groups which can be crosslinked by UV in an extremely short time to form contact lenses with very desirable properties so far unobtainable by conventional methods.

In some exemplary embodiments, the poly-HEMA is functionalized to form a crosslinkable prepolymer by attaching a crosslinkable functional group thereto. Generally the functional group can provide the ability to crosslink and form crosslinked polymers or hydrogels to the prepolymer. Suitable reactants that provide the crosslinkable functional groups have the structure A-S-F, where A is an attaching group which is capable of forming a covalent bond with a hydroxyl group in the poly-HEMA; S is a spacer and F is a functional group comprising an ethylenically unsaturated moiety. Suitable attaching groups, A, can include chloride, isocyanates, acids, acid anhydrides, acid chlorides, epoxies, azalactones, combinations thereof and the like. Preferred attaching groups can include acid anhydrides.

The spacer may be a direct bond, a straight, branched or cyclic alkyl or aryl group having 1 to 8 carbon atoms and preferably 1 to 4 carbon atoms or a polyether chain of the formula —(CH₂—CH₂—O)ₙ— where n is between 1 and 8 and preferably between 1 and 4.

Suitable functional groups comprise free radical polymerizable ethylenically unsaturated moieties. Suitable ethylenically unsaturated groups can have the formula

—C(R¹⁰)═CR¹¹R¹²

Where R¹⁰, R¹¹ and R¹² are independently selected from H, C₁₋₆ alkyl, carbonyl, aryl and halogen. Preferably R¹⁰, R¹¹ and R¹² are independently selected from H, methyl, aryl and carbonyl, and more preferably in some embodiments selected from H and methyl.

Preferred exemplary reactants can include methacrylic acid chloride, 2-isocyanatoethylacrylate, isocyanatoethyl methacrylate (IEM), glycidyl methacrylate, cinnamic acid chloride, methacrylic acid anhydride, acrylic acid anhydride and 2-vinyl-4-dimethylazalactone.

Suitable amounts of the crosslinkable functional group attached to the poly-HEMA can include from about 1 to about 20%, and preferably between about 1.5 to about 10%, and most preferably from about 2 to about 5% on a stoichiometric basis based upon the amount of available hydroxyl groups in the poly-HEMA. The degree of functionalization may be measured by known methods such as determination of unsaturated groups or by hydrolysis of the bond between the functional reactant and the polymer followed by determination of the released acid by HPLC.

Depending on the attaching group selected, the functionalization may be conducted with or without a conventional catalyst. Suitable exemplary solvents include polar, aprotic solvents which are capable of dissolving the poly-HEMA at the selected reaction conditions. Examples of suitable solvents include dimethylformamide (DMF), hexamethylphosphoric triamide (HMPT), dimethyl sulfoxide (DMSO), pyridine, nitromethane, acetonitrile, dioxane, tetrahydrofuran (THF) and N-methylpyrrolidone (NMP). Preferred solvents include formamide, DMF, DMSO, pyridine, NMP and THF. When IEM is used the catalyst is a tin catalyst and preferably dibutyl tin dilaurate.

The functionalization lens forming mixture may also contain a scavenger capable of reacting with moieties created by the functionalization. For example, when acid anhydrides are used as the attaching group, it may be beneficial to include at least one tertiary amine, a heterocyclic compound with an aprotic nitrogen or other lewis bases to react with the carboxyl group which is generated. Suitable tertiary amines include pyridine, triethylenediamine and triethylamine, with triethylamine being preferred. If included the tertiary amine may be include in a slight molar excess (about 10%). In a preferred embodiment the solvent is NMP, the reactant is methacrylic acid anhydride, acrylic acid anhydride or a mixture thereof and triethylamine is present. The most preferred reactant is methacrylic acid anhydride.

Exemplary reactions can be run at about room temperature. Each functional group may require a specific temperature range, which is understood by those of skill in the art. Ranges of about 0° C. and 50° C. and preferably about 5° C. and about 45° C. are generally suitable. Ambient pressures may be used. For example, when the crosslinkable functional group is an acid anhydride the functionalization is conducted at temperatures between about 5° C. and about 45° C. and for times ranging from about 20 to about 80 hours. It will be appreciated by those of skill in the art, that ranges outside those specified may be tolerated by balancing the time and temperatures selected. The reaction can be run to produce a crosslinkable prepolymer with a poly-HEMA backbone having a molecular weight and polydispersity as defined above.

Apart from attaching crosslinkable side groups other side groups may provide additional functionality including, but not limited to photoinitiators for crosslinking, pharmaceutical activity and the like. Still other functional groups may contain moieties that can bind and/or react with specific compounds when the crosslinked gels are used in analytical diagnostic applications.

In some exemplary embodiments, after the crosslinkable prepolymer has been formed, substantially all unreacted reactants and byproducts are removed. By “substantially all” we mean that less than about 0.1 weight % remains after washing. This can be done by conventional means, such as ultrafiltration. However, in the present invention, it may be possible to purify the cross-linkable prepolymer by swelling the prepolymer with water and rinsing with water to remove substantially all of the undesired constituents including monomeric, oligomeric or polymeric starting compounds and catalysts used for the preparation of the poly-HEMA and byproducts formed during the preparation of the crosslinkable prepolymer. Washing can be conducted with deionized water and conditions can be selected to provide a large surface to volume ratio of the crosslinkable prepolymer particles. This can be done by freeze drying the crosslinkable prepolymer, making a thin film from the crosslinkable prepolymer, extruding the crosslinkable prepolymer into rods, nebulizing the crosslinkable prepolymer solution into the deionized water, and other like methods, which are know to those skilled in the art.

Exemplary processes can include washings conducted in batches with about 3 to about 5 water replacements at room temperature and the equilibrium time between water replacements can be shortened by washing (extracting) at elevated temperatures below about 50° C. In some exemplary embodiments, water removes impurities which would leach out during storage and use, providing confidence that a pure material, suitable for the end use, has been produced.

In some embodiments unfractionated poly-HEMA having polydispersity outside the preferred range, or poly-HEMA from which only the high molecular weight material has been removed, is functionalized and the functionalized material is washed repeatedly with large volumes of water to remove reactants and poly-HEMA of low molecular weight. By this method a very pure functionalized poly-HEMA of low polydispersity such as below 2.0, preferred below 1.7 and more preferred below 1.5, can be obtained. The functionalized crosslinkable poly-HEMA obtained by this method comprises less than 10%, preferably less than 5% and more preferably less than 2% of poly-HEMA of molecular weight smaller than about 15,000.

The extent to which the small molecules should be removed depends on the degree of functionalization and the intended use. Preferably, during cure, all poly-HEMA molecules should become bound into the polymer network by at least two covalent bonds. Due to the statistical nature of the functionalization and the cure, the probability that a poly-HEMA molecule will be bound into the polymer network through only one covalent bond or none at all increases with decreasing peak molecular weight and decreasing degree of functionalization.

For lower functionalization relatively more of the low molecular weight material should be removed. The correct amount can easily be determined by experiments comparing removal and mechanical properties.

Once the crosslinkable prepolymer has been purified it can then dissolved in a water replaceable diluent to form a viscous solution. The diluent can function as a medium in which the crosslinkable functionalized poly-HEMA prepolymer can be dissolved and in which the crosslinking reaction or cure can take place. In all other respects the diluent should be non-reactive. Suitable diluents include those capable of dissolving, at or below 65° C., between about 30 weight % to about 60 weight % crosslinkable prepolymer based upon the total weight of the viscous solution. Specific examples include alcohols having one to four carbon atoms, and preferably methanol, ethanol, propanol and mixtures thereof. Water may be used as a co-diluent in minor amounts such as less than about 50% of the total diluent. For hydrogels, diluents should be added to the crosslinkable prepolymer in an amount which is approximate or equal to the amount of water present in the final hydrogel. Diluent amounts between about 40 and about 70 weight % of the resulting viscous solution are acceptable.

Viscous solutions may have a viscosity of about 50,000 cps to about 1×10⁷ cps at 25° C., preferably of about 100,000 cps to about 1,000,000 cps at 25° C., and more preferably of about 100,000 cps to about 500,000 cps at 25° C.

Preferably the diluents are also safe for the article's intended end use. So, for example, when the article being formed is a contact lens, the solvent should preferably be safe for ocular contact and ophthalmically compatible. Diluents that will not be evaporated from the resulting article should have the capability to bring the Tg of the viscous solution to below about room temperature, (preferably a Tg less than about −50° C.) and low vapor pressures (boiling point above about 180° C.). Examples of biocompatible diluents include polyethylene glycols, glycerol, propylene glycol, dipropylene glycol mixtures thereof and the like. Preferred polyethylene glycols have molecular weights between about 200 and 600. Use of biocompatible diluents allows the removal of a separate washing/evaporation step to remove the diluents.

Low boiling diluents may also be used, but may require an evaporation step for diluents which are not compatible with the intended use environment. Low boiling diluents are polar and generally have low boiling points (less than about 150° C.), which make removal via evaporation convenient. Suitable low boiling diluents include alcohols, ethers, esters, glycols, mixtures thereof and the like. Preferred low boiling diluents include alcohols, ether alcohols, mixtures thereof and the like. Specific examples of low boiling diluents include 3-methoxy-1-butanol, methyl lactate, 1-methoxy-2-propanol, 1-ethoxy-2-propanol, ethyl lactate, isopropyl lactate, mixtures thereof and the like.

A polymerization initiator may also be added. The initiator may be any initiator that is active at the processing conditions. Suitable initiators include thermally activated, photoinitiators (including UV and visible light initiators) and the like. Suitable thermally activated initiators include lauryl peroxide, benzoyl peroxide, isopropyl percarbonate, azobisisobutyronitrile, 2,2-azobis isobutyronitrile, 2,2-azobis 2-methylbutyronitrile and the like. Suitable photoinitiators include aromatic alpha hydroxyketone or a tertiary amine plus a diketone. Illustrative examples of photoinitiator systems are 1-hydroxycyclohexylphenyl ketone, 2-hydroxy-methyl-1-phenyl-propan-1-one, benzophenone, thioxanthen-9-one, a combination of camphorquinone and ethyl-4-(N,N-dimethylamino)benzoate or N-methyldiethanolamine, hydroxycyclohexyl phenyl ketone, bis(2,4,6-trimethylbenzoyl)-phenyl phosphine oxide and bis(2,6-dimethoxybenzoyl)-2,4,4-trimethylpentyl phosphine oxide, (2,4,6-trimethylbenzoyl)diphenyl phosphine oxide and combinations thereof and the like. Photoinitiation is a preferred method and bis(2,6-dimethoxybenzoyl)-2,4,4-trimethylpentyl phosphine oxide, bis(2,4,6-trimethylbenzoyl)-phenyl phosphine oxide and 2-hydroxy-methyl-1-phenyl-propan-1-one are preferred photoinitiators. Other initiators are known in the art, such as those disclosed in U.S. Pat. No. 5,849,841, at column 16, the disclosure of which is incorporated herein by reference.

Other additives which may be incorporated in the prepolymer or the viscous solution include, but are not limited to, ultraviolet absorbing compounds, reactive dyes, organic and inorganic pigments, dyes, photochromic compounds, release agents, antimicrobial compounds, pharmaceuticals, mold lubricants, wetting agents, other additives desirable to maintain a consistent product specification, (such as but not limited to TMPTMA) combinations thereof and the like. These compositions may be added at nearly any stage and may be copolymers, attached or associated or dispersed.

The viscous solution should preferably not contain compounds such as free monomers which can, during cure, give polymer material which is not bound up in the network and/or will give residual extractable material.

Exemplary viscous solutions may have beneficially short relaxation times. Relaxation times are preferred to be less than about 10 seconds, preferably less than about 5 seconds and more preferably less than about 1 second. Short relaxation times can be beneficial because prepolymers having them are capable of relieving flow induced stresses prior to curing so the cured polymer network is free of locked-in stresses. This facilitates the viscous solutions of the present invention to be processed without long “hold” times between closing the mold and curing the viscous solution.

In some embodiments, in order to limit unwanted stresses on the lens, it is beneficial to allow the viscous solution to rest in the closed mold for a period two to three times longer than the viscous solution's relaxation time. In some embodiments, the viscous solution of the present invention may have beneficially short relaxation times at room temperature (less than about 10 seconds, preferably less than about 5 seconds, and more preferably less than about 1 second) which allow for hold times which are generally less than about 30 seconds, preferably less than about 10 seconds and more preferably less than about 5 seconds.

An additional benefit of short holding times can include minimimal oxygen diffusion into the crosslinkable prepolymer from the mold parts. Diffusion of oxygen can impair the curing process at the surface of the article. It will be appreciated that the viscous solution may be held for longer than the times specified in low oxygen content molds with minimal or no negative impact other than slower production times.

A mold containing the viscous solution can be exposed to ionizing or actinic radiation, for example electron beams, X-rays, UV or visible light, ie. electromagnetic radiation or particle radiation having a wavelength in the range of from about 280 to about 650 nm. Also suitable are UV lamps, HE/Cd, argon ion or nitrogen or metal vapor or NdYAG laser beams with multiplied frequency. The selection of the radiation source and initiator are known to those of skill in the art. Those of skill in the art will also appreciate that the depth of penetration of the radiation in to the viscous solution and the crosslinking rate are in direct correlation with the molecular absorption coefficient and concentration of the selected photoinitiator. In a preferred embodiment the radiation source is selected from UVA (about 315- about 400 nm), UVB (about 280- about 315) or visible light (about 400- about 450 nm), at high intensity. As used herein the term “high intensity” means those between about 100 mW/cm² to about 10,000 mW/cm². The cure time is short, generally less than about 30 seconds and preferably less than about 10 seconds. The cure temperature may range from about ambient to elevated temperatures of about 90° C. For convenience and simplicity the curing is preferably conducted at about ambient temperature. The precise conditions will depend upon the components of lens material selected and are within the skill of one of ordinary skill in the art to determine.

The cure conditions must be sufficient to form a polymer network from the crosslinkable prepolymer. The resulting polymer network is swollen with the diluent and has the form of the mold cavity 105.

Once curing is completed, the molds are opened. Post molding purification steps to remove unreacted components or byproducts are either simplified compared to conventional molding methods, or are not necessary in the present invention. If a biocompatible diluent is used no washing or evaporating step is required at this phase either. It is an advantage of the present invention that when a biocompatible diluent is used, both post molding extraction and diluent exchange steps are not required. If a low boiling diluent is used, the diluent should be evaporated off and the lens hydrated with water.

Some exemplary resulting lenses comprise a polymer network, which when swelled with water becomes a hydrogel. Hydrogels may comprise between about 20 to about 75 weight % water, and preferably between about 20 to about 65 weight % water. Hydrogels may have excellent mechanical properties, including modulus and elongation at break. The modulus can be about 20 psi or more, preferably between about 20 and about 90 psi, and more preferably between about 20 and about 70 psi.

While the present invention has been particularly described above and drawings, it will be understood by those skilled in the art that the foregoing ad other changes in form and details may be made therein without departing from the spirit and scope of the invention, which should be limited only by the scope of the appended claims.

What is claimed is:

1. A method of forming an ophthalmic lens, the method comprising the steps of:
dosing an amount of a lens forming mixture comprising a prepolymer into a first mold part, wherein the first mold part comprises a lens forming surface and a vent forming portion;
assembling a second mold part to the first mold part;
applying a predetermined pressure joining the first mold part and the second mold part and forming the prepolymer into a desired shape of the ophthalmic lens within a cavity formed between the first mold part and the second mold part and also forming a vent portion around a perimeter of the lens forming surface;
expelling atmospheric gas through the vent portion; and
curing the prepolymer to fashion the ophthalmic lens.

2. The method of claim 1 wherein the prepolymer comprises poly-HEMA or silicone having a peak molecular weight about 25,000 with a polydispersity of less than about 2 to a peak molecular weight of about 100,000 with a polydispersity of less than about 3.8.

3. The method of claim 1 wherein the step of dosing the prepolymer comprises:
dosing with precision tolerance of plus or minus 2 milligrams of a predetermined dose amount.

4. The method of claim 1 wherein the predetermined dose amount comprises between about 25 to 35 milligrams.

5. The method of claim 1 wherein at least one of the first mold part and the second mold part is fashioned from a material comprising a polyolefin.

6. The method of claim 1 wherein the predetermined pressure joining the first mold part and the second mold part comprises a force less than a force sufficient to deform one or more of the first mold part and the second mold part.

7. The method of claim 1 wherein the predetermined pressure joining the first mold part and the second mold part comprises a force of between about 1 kilogram and 10 kilogram of force

8. The method of claim 1 wherein at least one of the first mold part and the second mold part comprises an area capable of transmitting sufficient light energy to cure the prepolymer.

9. The method of claim 8 wherein the sufficient light to cure the prepolymer comprises a frequency of between about 350 to 600 nanometers.

10. The method of claim 1 wherein one or both of the first mold part and the second mold part comprise a reusable mold part capable of molding multiple ophthalmic lenses.

11. The method of claim 10 wherein one or both of the first mold part and the second mold part comprise a metallic material.

12. The method of claim 10 wherein one or both of the first mold part and the second mold part comprise one or more of: glass and quartz.

13. The method of claim 1 wherein at least one of the first mold part and the second mold part comprises an area capable of transmitting sufficient light energy to sterilize the formed ophthalmic lens.

14. The method of claim 1, wherein the ophthalmic lens comprises a silicone hydrogel contact lens.

15. Molding apparatus for fashioning an ophthalmic lens from a prepolymer, the molding apparatus comprising:
a first mold part comprising: a) a concave lens surface area capable for receiving a prepolymer and comprising optical qualities to be imparted into a lens formed within the concave lens surface area, b) a first vent forming portion, and c) an alignment taper portion; and
a second mold part comprising: a) a convex lens surface area which when positioned proximate to the concave lens surface area forms an ophthalmic lens forming cavity, b) a second vent forming portion which when positioned proximate to the first vent forming portion defines a vent fluidly connecting the lens forming cavity to an ambient area, and c) an alignment taper portion.
an area transmissive to light energy effective to cure the prepolymer.

16. The molding apparatus of claim 15 additionally comprising an area in one or both of the first mold part and the second mold transmissive to light energy effective to cure the prepolymer.

17. The molding apparatus of claim 15 wherein at least one of the first mold part and second mold part comprises a cyclic olefin of sufficient modulus to withstand a stopping load of between about kilogram and 10 kilogram of force without deformation sufficient to deform a lens formed in the lens forming cavity.

18. The molding apparatus of claim 15 wherein at least one of the first mold part and second mold part comprises a metallic mold part suitable for forming multiple ophthalmic lenses.

19. The molding apparatus of claim 15 wherein the vent portion comprises a channel of between about 0.001 mm to about 0.20 mm wide.

20. The molding apparatus of claim 15 wherein the vent portion comprises a channel of between about 0.003 mm to about 0.10 mm wide.
